(19) United States
(12) Patent Application Publication
(10) Pub. No.: US 2012/0175019 A1
(43) Pub. Date: Jul. 12, 2012

(54) TWO-SIDED WOOD WORKING PLANNER

(76) Inventor: Bor-Yann CHUANG, Taichung City (TW)

(21) Appl. No.: 13/004,937

(22) Filed: Jan. 12, 2011

(51) Int. Cl. B27C 1/08

(52) U.S. Cl. 144/130

(57) ABSTRACT

A two-sided wood working planner includes a base which is coupled with an adjustment seat. The adjustment seat includes a front press rod, at least one rear press rod and an upper plane blade which are pivotally connected in the adjustment seat. The adjustment seat further includes two movable units at two opposing sides thereof. The front press rod has a rod body. The rod body has an outer wall provided with a plurality of protruding members. Each of the protruding members has a head extended out of the outer wall of the rod body. When the front press rod is operated to send the material, the protruding members will hold against the workpiece to form point contact with the workpiece. In this way, the workpiece can be pressed effectively and the workpiece won't be deformed, so that the two-sided wood working planner can exactly plane the workpiece.

### BACKGROUND OF THE INVENTION

1. Field of the Invention

The present invention relates to a front press rod structure of a two-sided wood working planner.

2. Description of the Prior Art

A conventional wood working planner comprises a base, a lower plane blade on the base, and an adjustment seat which is mounted above the lower plane blade. The adjustment seat comprises a front press rod, a plurality of rear press rods, an upper plane blade and a power rod. When in use, the user places a workpiece, such as a plank, on the base. The workpiece is moved toward the upper and lower plane blades by the power rod. The front and rear press rods are adapted to secure the workpiece, preventing the workpiece from unexpected movement, so that the upper and lower plane blades can plane the workpiece.

However, the workpiece may have defects before planed, such as curve. The front press rod is integrally formed. When the front press rod presses the workpiece, the outer wall of the front press rod will be linear contact with the surface of the workpiece to press the curved portion of the workpiece which has internal stresses. After the workpiece is planed, the curved portion is still curved. The conventional wood working planner cannot plane the workpiece effectively. Accordingly, the inventor of the present invention has devoted himself based on his many years of practical experiences to solve this problem.

### SUMMARY OF THE INVENTION

The primary object of the present invention is to provide a two-sided wood working planner. The two-sided wood working planner comprises a base, an adjustment seat and a front press rod. The base comprises a worktable thereon. The worktable has a front end and an opposing rear end. The worktable of the base is pivotally connected with a lower plane blade. The base further includes a plurality of straight adjustment screws on a circumferential portion thereof. The adjustment seat has a plurality of adjustment holes corresponding to the adjustment screws. The adjustment screws are screwed to the adjustment holes. The adjustment seat is mounted above the worktable and parallel to the worktable. The adjustment seat comprises at least one rear press rod and an upper plane blade which are transversely disposed in the adjustment seat in sequence from the front end to the rear end of the worktable. The adjustment seat further comprises two movable units at two opposing sides thereof. The two movable units are located in front of the rear press rod. The front press rod has a rod body. Two ends of the rod body are pivotally connected to the two movable units so that the rod body can be moved up and down in the adjustment seat. The rod body has an outer wall provided with a plurality of protruding members. Each of the protruding members has a head extended out of the outer wall of the rod body.

The protruding members of the two-sided wood working planner of the present invention are extended out of the outer wall of the rod body, and the two ends of the rod body are pivotally connected to the two movable units. When the front press rod is operated to send the material, the protruding members will hold against the workpiece to form point contact with the workpiece. In this way, the workpiece can be pressed effectively and the workpiece won't be deformed, so that the two-sided wood working planner can exactly plane the workpiece.

### BRIEF DESCRIPTION OF THE DRAWINGS

FIG. 1 is an exploded view according to a preferred embodiment of the present invention;

FIG. 2 is a partially cross-sectional view according to the preferred embodiment of the present invention;

FIG. 3 is an enlarged view showing the front press rod of the present invention; and

FIG. 4 is a schematic view of the preferred embodiment of the present invention when in use.

### DETAILED DESCRIPTION OF THE PREFERRED EMBODIMENTS

Embodiments of the present invention will now be described, by way of example only, with reference to the accompanying drawings.

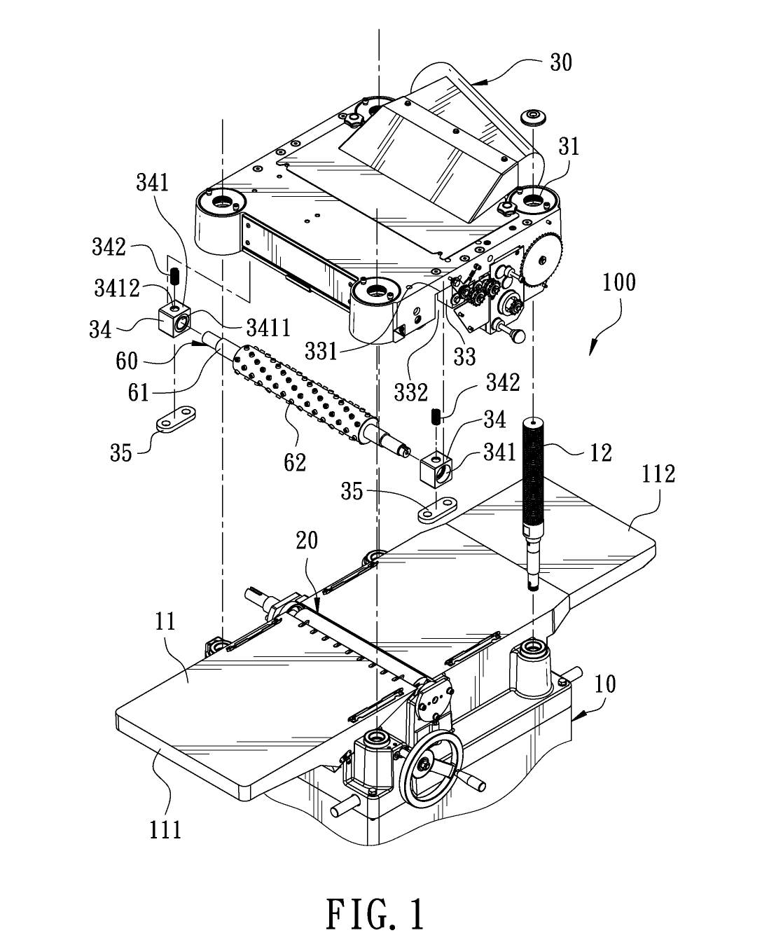

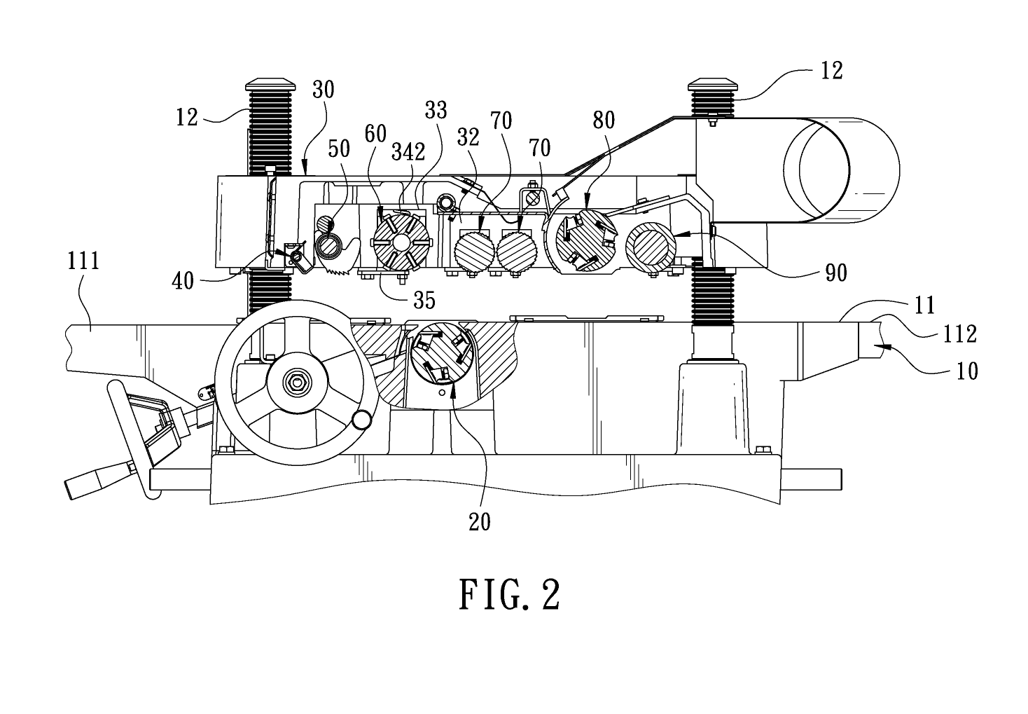

As shown in FIG. 1 and FIG. 2, a two-sided wood working planner 100 according to a preferred embodiment of the present invention comprises a base 10 and an adjustment seat 30.

The base 10 comprises a worktable 11 thereon. The worktable 11 has a front end 111 and an opposing rear end 112. The worktable 11 of the base 10 is pivotally connected with a lower plane blade 20. The base 10 further includes a plurality of straight adjustment screws 12 on a circumferential portion thereof.

The adjustment seat 30 has a plurality of adjustment holes 31 corresponding to the adjustment screws 12. The adjustment screws 12 are screwed to the adjustment holes 31, such that the adjustment seat 30 is mounted above the worktable 11 and parallel to the worktable 11. The adjustment seat 30 has a chamber 32 at one side thereof facing the worktable 11. The adjustment seat 30 comprises a pre-press plate 40, a toothed stop member 50, a front press rod 60, two rear press rods 70, an upper plane blade 80 and a power rod 90 which are transversely disposed in the chamber 32 in sequence from the front end 111 to the rear end 112 of the worktable 11. The adjustment seat 30 has two slide troughs 33 at two opposing sides thereof. The two slide troughs 33 are located in front of the rear pressure rods 70. Each of the two slide troughs 33 is provided with a movable unit 34. The movable unit 34 has a connection block 341. The connection block 341 has a connection through hole 3411 and a recess 3412 on a top end thereof. A compressed spring 342 is provided in the recess 3412. Another end of the compressed spring 342 is against a top end 331 of the slide trough 33. The adjustment seat 30 further comprises a stop plate 35 at a lower end 332 of the slide trough 33 to confine the movable unit 34 within the slide trough 33.

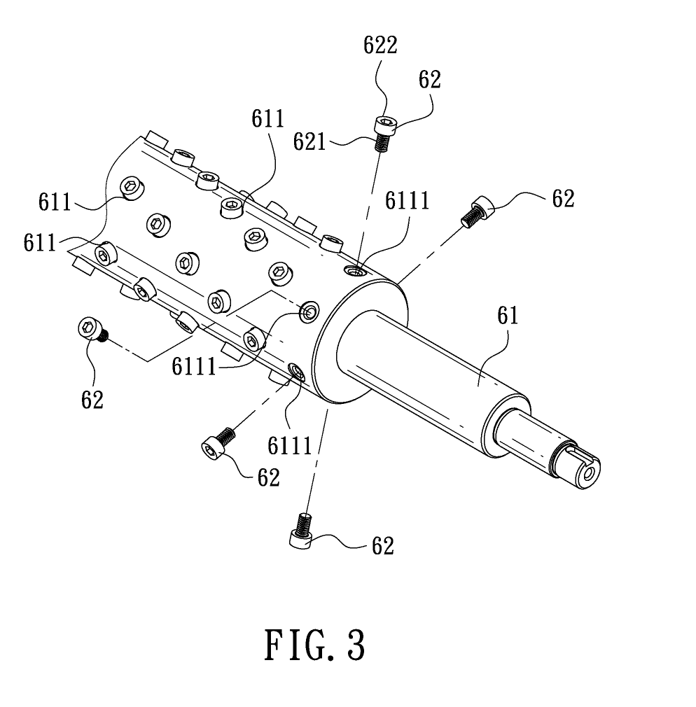

FIG. 3 is an enlarged view showing the front press rod of the present invention. The front press rod 60 has a rod body 61 and a plurality of protruding members 62. Two ends of the rod body 61 are pivotally connected to the connection through holes 3411 of the two connection blocks 341, so that the rod body 61 can be moved up and down in the adjustment seat 30. The rod body 61 has an outer wall formed with a plurality of spiral rows 611 of spaced threaded holes 6111. The spiral rows 611 are parallel to each other.

The protruding members 62 are disposed on the outer wall of the rod body 61. In this embodiment, the protruding members 62 are bolts screwed in the threaded holes 6111. Each of the protruding members 62 has a threaded portion 621 and a head 622. The threaded portion 621 is screwed in the threaded hole 6111, and the head 622 is extended out of the outer wall of the rod body 61.

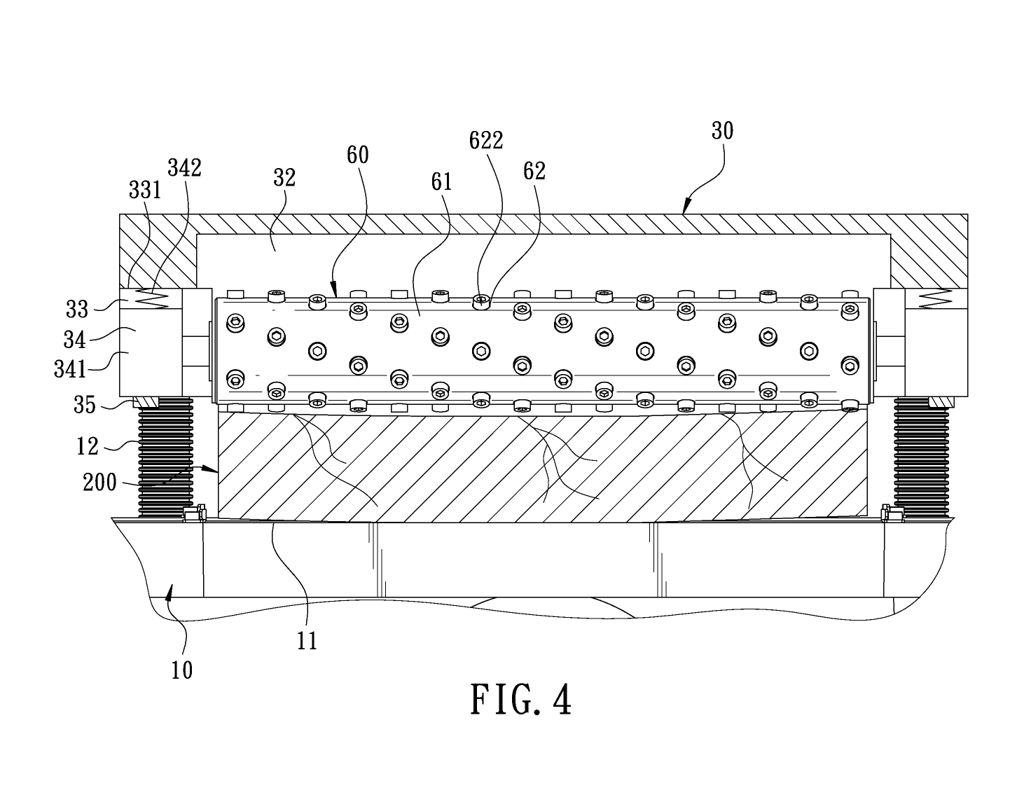

FIG. 4 is a schematic view of the preferred embodiment of the present invention when in use. When the user uses the two-sided wood working planner 100 to plane a workpiece 200 which has curved sides, the workpiece 200 is first placed on the worktable 11. The workpiece 200 is moved toward the lower plane blade 20 and the upper plane blade 80 by the power rod 90. At this moment, the workpiece 200 is initially secured by the pre-press plate 40, preventing the workpiece 200 from shaking unexpectedly. The toothed stop member 50 is adapted to prevent the workpiece 200 from bouncing in the reverse direction during the operation. The heads 622 of the protruding members 62 are extended out of the outer wall of the rod body 61, and the two ends of the rod body 61 are pivotally connected to the two connection blocks 341. The compressed spring 342 is located between the connection block 341 and the top end 331 of the slide trough 33. When the front press rod 60 is operated to send the material, the heads 622 of the protruding members 62 will hold against the workpiece 200 to form point contact with the workpiece 200. In this way, the workpiece 200 can be pressed effectively and the workpiece 200 won't be deformed, so that the lower plane blade 20 can exactly plane the bottom of the workpiece 200. After the bottom of the workpiece 200 is planed to be a plane, the upper plane blade 80 is used to plane the top of the workpiece 200 when the rear press rods 70 press the workpecie 200 which won't be deformed.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A two-sided wood working planner, comprising:
a base comprising a worktable thereon, the worktable having a front end and an opposing rear end, the worktable of the base being pivotally connected with a lower plane blade, the base further including a plurality of straight adjustment screws on a circumferential portion thereof;
an adjustment seat having a plurality of adjustment holes corresponding to the adjustment screws, the adjustment screws being screwed to the adjustment holes, the adjustment seat being mounted above the worktable and parallel to the worktable, the adjustment seat comprising at least one rear press rod and an upper plane blade which are transversely disposed in the adjustment seat in sequence from the front end to the rear end of the worktable, the adjustment seat further comprising two movable units at two opposing sides thereof, the two movable units being located in front of the rear press rod; and
a front press rod having a rod body, two ends of the rod body being pivotally connected to the two movable units so that the rod body is movable up and down in the adjustment seat, the rod body having an outer wall provided with a plurality of protruding members, each of the protruding members having a head extended out of the outer wall of the rod body.

2. The two-sided wood working planner as claimed in claim 1, wherein the outer wall of the rod body is formed with a plurality of spiral rows of spaced threaded holes, the spiral rows are parallel to each other, and the protruding members are screwed to the threaded holes.

3. The two-sided wood working planner as claimed in claim 1, wherein the protruding members are bolts.

4. The two-sided wood working planner as claimed in claim 1, wherein the adjustment seat has two slide troughs at the two opposing sides thereof, the two slide troughs being located in front of the rear pressure rod, the two movable units being respectively provided in the two slide troughs, the two movable units each having a connection block, the connection block having a connection through hole for connection of the rod body of the front press rod, the two movable units each comprising a compressed spring disposed between the connection block and a top end of the respective slide trough.
